(19) United States
(12) Patent Application Publication
(10) Pub. No.: US 2010/0090522 A1
(43) Pub. Date: Apr. 15, 2010

(54) METHOD AND DEVICES FOR OPERATING A MOTOR VEHICLE BRAKE DEVICE

(76) Inventors: Uwe Bensch, Hannover (DE); Henning Förster, Nordstemmen (DE); Jörg Helmer, Vogt (DE); Hartmut Rosendahl, Hannover (DE); Marcel Schlottmann, Gehrden (DE); Otmar Struwe, Hannover (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/448,393

(22) PCT Filed: Nov. 10, 2007
(86) PCT No.: PCT/EP2007/009749

§ 371 Date: Jun. 17, 2009

(30) Foreign Application Priority Data
Jan. 11, 2007 (DE) 10 2007 001 708.3

(51) Int. Cl. B60T 8/88; B60T 8/32

(52) U.S. Cl. 303/122.15; 303/127

(57) ABSTRACT

The invention relates to a method for operating a brake device of a motor vehicle, comprising a service brake (16) and a parking brake (14). Upon activation of a rolling brake function (S1), and achieving a full stop of the vehicle, monitoring (S2) of an actuating element occurs with regard as to whether a driver has contact with an actuating element. In order to improve the safety of the rolling brake function, the invention provides that, if the monitoring (S2) finds that the driver has no contact with the actuating element, the parking brake (14) is applied (S3), or a braking pressure (14) is controlled using the service brake (16), the braking pressure corresponding to the maximum braking pressure (S10) that can be generated by the parking brake (14), by means of an electric or electronic brake device (26) for controlling the service brake (16) and the parking brake (14). The invention further relates to a corresponding method, wherein a monitoring (S11) of the vehicle occurs with regard to a possible displacement of the vehicle, and if the monitoring shows that the vehicle has been set in motion, braking is applied (S12) to all wheels of the vehicle that are connected to service brake (16) by means of the control device (26) via the service brake (16). The invention also relates to devices that are configured accordingly.

The present invention generally relates to a method for operating a brake device of a vehicle having a service brake and a parking brake according to the preambles of claims 1 and 5, and a corresponding device according to the preambles of claims 10 and 17.

Such brake devices are used in motor vehicles with electronic brake systems. These brake systems generally have a service brake and a parking brake. The service brake is used during the driving mode of the vehicle. It serves to brake the vehicle during operation, including to temporarily stop the vehicle in a stationary position, for example at a traffic light, a bus stop or while starting on an incline.

In addition, such a brake system has what is referred to as a parking brake. It is used to prevent a parked vehicle from rolling away.

The vehicle has spring accumulator/diaphragm brake cylinders which are generally combined to implement a parking brake. Such brake cylinders have both the function of diaphragm brake cylinders as well as a spring accumulator function. These brake cylinders each comprise a diaphragm component and a spring accumulator component. The diaphragm component is connected pneumatically to the service brake system and the actual service brake pressure can be applied to it. The spring accumulator component is pneumatically separated from the diaphragm component and compressed air can be applied to it via separate compressed air lines.

The spring accumulator component implements the spring accumulator function by pre-stressing a storage spring when the spring accumulator component has compressed air applied to it, and reducing a braking effect of the storage spring in the process. When the spring accumulator component is vented, the storage spring relaxes, with the result that a braking effect within the scope of the spring accumulator function is applied to the brake which is connected to the respective brake cylinder. Brake cylinders of this type are referred to hereinafter as “spring accumulator brake cylinders”. The parking brake, which permits the vehicle to be secured in position or braked even when compressed air is absent, is implemented by such spring accumulator brake cylinders.

A function which can be implemented with a service brake and a parking brake in conjunction with an electronic brake system is to maintain the brake pressure when the vehicle has stopped. When the vehicle has stopped, the driver can take his foot off the brake pedal without the service brake being released and the vehicle rolling away. However, for this purpose, it is necessary to actuate beforehand a corresponding rolling brake function, also referred to as an “anti-roll lock”, or to operate a control element which actuates the rolling brake function.

After such actuation has occurred and the stationary state of the vehicle has been achieved, the modulated pressure of the service brake is locked in so that the brake pressure which was last modulated is maintained. This function is referred to as a “hill holder function”. When the driver is starting, he can therefore concentrate on the pure starting process, which appreciably facilitates the starting process for the driver.

A similar embodiment of the rolling brake function is what is referred to as the “bus stop brake” which is provided for the use of buses and can be actuated at bus stops. By actuating a corresponding switch, a predetermined, parameterizable pressure that is intended to hold the vehicle is modulated in the brake system. In contrast to this predetermined, parameterizable pressure, which is modulated when the switch is actuated, in the case of the hill holder function described above, the brake pressure that is modulated when the vehicle is stopped is maintained, and it can vary depending on the driving situation.

This known rolling brake function is carried out by means of the service brake. A disadvantage of this known solution is that the vehicle rolls away if the service brake pressure decreases, for example due to a fault in the electrical power supply, due to a drop in pressure or due to a fault in the electronic brake system.

During an actuated rolling brake function, the driver must not leave the driver's seat in order to be able to intervene directly in the service brake circuit when the rolling brake function is unintentionally released or the brake pressure decreases. The rolling brake function does not, in fact, make available a reliable parking brake. Instead, it is necessary to allow for the fact that the vehicle will automatically begin to move, for example if the engine stalls or the electrical power supply fails.

However, a driver occasionally uses the service brake instead of the parking brake to park the vehicle for a longer period of time. This does not correspond, however, to the correct use of the service brake. The vehicle can, in fact, roll away if the service brake pressure decreases.

Various solutions for increasing the safety of such systems have been proposed.

In known systems, for example a safety interrogation is provided that detects if the driver leaves the driver's seat. As soon as the driver leaves his seat—when the rolling brake function is actuated—a warning signal is output and the anti-roll lock is released. As a result, the driver is warned and forced not to leave his seat and to immediately actuate the brake pedal again.

DE 103 36 611 A1 provides for the parking brake to be actuated if, for example, a defect occurs in the brake system when the rolling brake function is actuated.

In addition, EP 0 976 628 B1 provides for an acoustic signal to be triggered, starting from the time of a completed holding process initiated by means of the service brake after a first delay time has expired if the holding state is held exclusively by means of the service brake. After a further second delay time following the first delay time has expired, the parking brake is generated automatically if the vehicle has remained in the stationary state until then by means of the service brake.

However, many of the known systems have deficiencies in terms of their safety.

The present invention is therefore directed to increasing the safety of anti-roll locks.

The present invention solves this problem by means of a method according to claim 1 and a method according to claim 5, respectively, and a device according to claim 10 and a device according to claim 17, respectively.

According to a first aspect of the invention, an actuation of an actuation element by the driver is monitored, and as soon as the driver no longer touches or actuates the actuation element, i.e., no longer maintains contact with the actuation element, the parking brake is automatically engaged. This provides a very high degree of safety. Even if the driver leaves the vehicle despite the vehicle being protected only by actuating the rolling brake function, the spring accumulators are actuated and therefore the parking brake is engaged. A high degree of safety when using the rolling brake function is therefore achieved.

The parking brake can be engaged directly on all the wheels and at the same time the service brake is released. Alternatively, the service brake can be released in steps.

The actuation element that is to be monitored is preferably a pedal which is arranged in the driver's cab in the region of the driver's seat, for example the brake pedal. However, in alternative embodiments, the actuation element can also be the clutch pedal or the accelerator pedal. Monitoring the clutch pedal or the accelerator pedal has the advantage that when the driver starts the vehicle he does not at first have to take his foot off the brake pedal but rather can initiate the starting process directly by actuating the accelerator pedal and, if appropriate, by closing the clutch.

In a further embodiment, the actuation element is a manual actuation element that is arranged in the driver's cab, such as, for example, a momentary contact switch, in particular a sensor that detects movement or contact.

One embodiment of the present invention provides that, at first, just a first group of wheels, preferably the wheels of the rear axle, which are equipped with spring accumulator brake cylinders, are switched over from having the service brake applied to them to having the parking brake applied to them. Here, the service brake is released at the corresponding wheels and, at the same time, the parking brake is engaged. The anti-roll lock is not completely deactivated, i.e., the service brake is also released at all the other wheels, until after a second time period following the first time period. The vehicle is then held by only the parking brake. This is advantageous because, for example, on a roadway with a steep positive gradient or a large negative gradient it is not always possible, in particular when the coefficient of friction of the roadway is low, for the vehicle to be held solely by the parking brake. This mode of operation avoids the situation in which the vehicle begins to move in a creeping fashion because the driver has relied on the anti-roll lock by the parking brake to secure the vehicle, and has left the vehicle.

An acoustic or visual warning signal, which indicates the imminent change in the braking state, is advantageously output just before the first and/or second time period expires. The driver can then dedicate his full attention to the state of the vehicle. That is, he can pay attention in particular to whether the vehicle begins to move and, if appropriate, he can actuate the service brake by depressing the brake pedal.

According to a further aspect of the invention, the actuation element, in particular a pedal such as the brake pedal, is once again monitored for contact with the driver, to determine whether the driver maintains contact with the actuation element. However, as soon as the monitoring reveals that the driver is not maintaining any contact with the actuation element, in particular that the driver's foot is no longer in contact with the pedal, for example the brake pedal, a brake pressure that can be generated by the spring accumulators is modulated automatically, i.e., by means of an electrical or electronic control device, to the service brake component of the brake system. In this way, the driver can determine whether the vehicle can be at all secured by means of the parking brake. As already stated, it is, in fact, possible that the braking force of the parking brake alone will not be sufficient, for example on a steep negative gradient, to hold the vehicle. If this is the case, the parking brake should likewise not be engaged since it does not provide sufficient protection against the vehicle rolling away independently. For this purpose, a check is initially carried out to determine whether the brake pressure that can be generated by the parking brake would be sufficient to hold the vehicle. If this is the case, the parking brake can then be engaged.

According to a further aspect of the present invention, the driving state of the vehicle is monitored, i.e., monitoring is carried out to determine whether the vehicle is travelling or stationary. This monitoring is either carried out continuously or after the rolling brake has been actuated and when the stationary state of the vehicle has been achieved. If the vehicle then begins to move again, this means failure of the rolling brake function, and therefore relatively large braking forces have to be applied to the wheels of the vehicle. For this purpose, all the wheels that are connected to the service brake are then braked by means of the service brake. This also allows for the fact that on a large positive gradient the vehicle cannot be held solely by the parking brake. For this purpose, the service brake is then additionally automatically actuated, i.e., the actuation of the service brake is triggered by a control device.

In this case, a warning signal that can be implemented, for example, as an acoustic and/or visual warning signal by means of a horn and/or a flashing warning light, is advantageously output at the same time.

The brake device and, if appropriate, its components, are also advantageously monitored. If the monitoring reveals that there is a fault in the brake device and/or in its components, in particular a brake circuit has failed and/or the electrical power supply is interrupted, the parking brake is automatically engaged.

For a fuller understanding of the present invention, reference is had to the following exemplary embodiments which are explained in greater detail with reference to the accompanying drawings, in which:

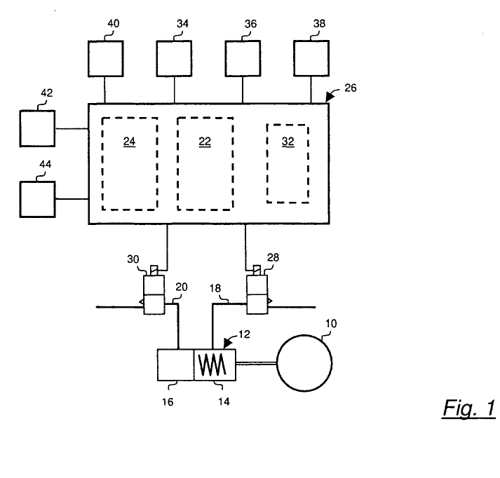

FIG. 1 is a schematic illustration of a device according to an exemplary embodiment of the present invention;

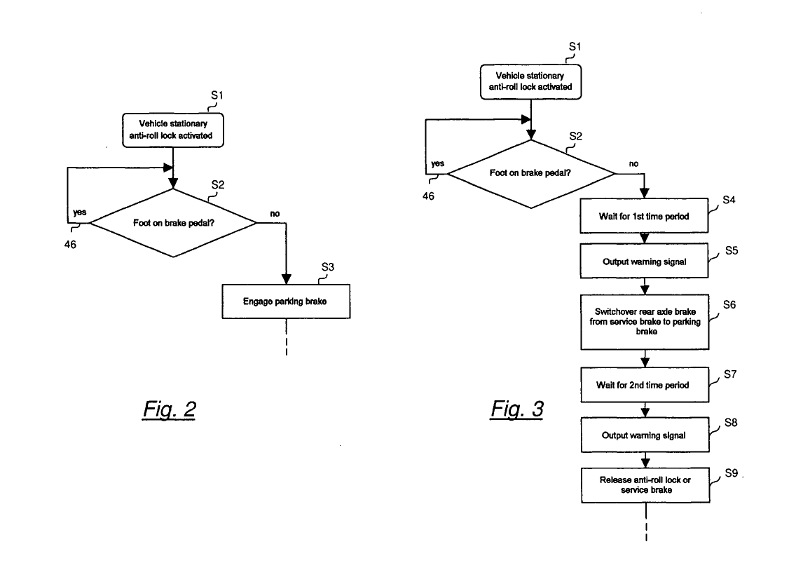

FIG. 2 is a simplified flowchart illustrating a first exemplary embodiment of a method according to the present invention;

FIG. 3 is a simplified flowchart illustrating a second exemplary embodiment of a method according to the present invention;

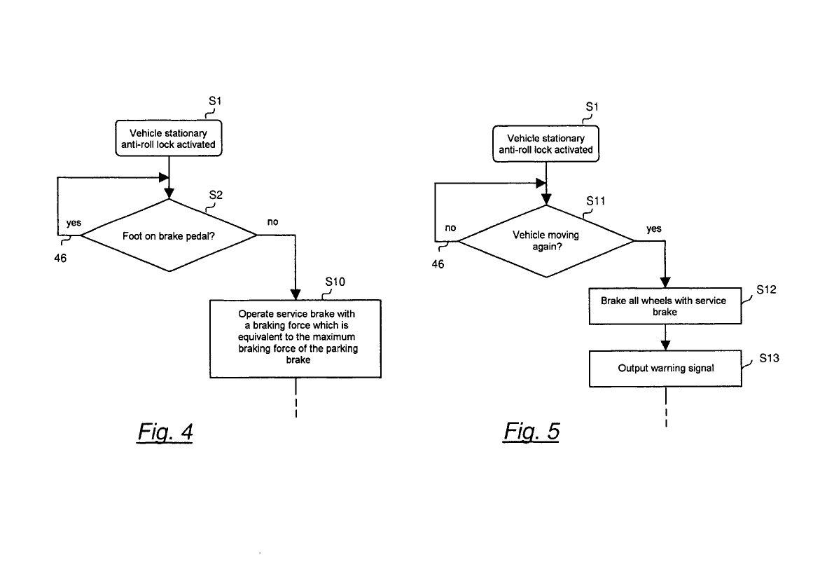

FIG. 4 is a simplified flowchart illustrating a third exemplary embodiment of a method according to the present invention;

FIG. 5 is a simplified flowchart illustrating a fourth exemplary embodiment of a method according to the present invention; and

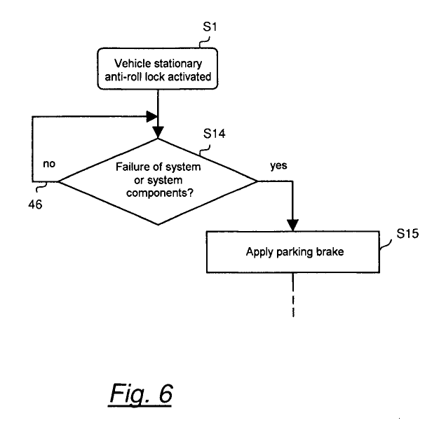

FIG. 6 is a simplified flowchart illustrating a fifth exemplary embodiment of a method according to the present invention.

FIG. 1 is a schematic view of a device for operating a brake device of a motor vehicle, in particular of a utility vehicle, truck or bus.

The vehicle has a plurality of wheels 10, of which, however, only one is illustrated. At least some of these wheels are braked by means of spring accumulator brake cylinders 12 which are embodied as discussed above. That is, each spring accumulator brake cylinder 12 has a spring accumulator component 14 for the parking brake and a diaphragm component 16 for the service brake. In order to release the spring accumulator brake or parking brake, spring accumulator component 14 must be ventilated. This ventilation is carried out by means of a compressed air line 18. In order to apply the parking brake, spring accumulator component 14 must be vented. This venting can also be carried out via compressed air line 18.

The service brake is provided by means of diaphragm component 16. If diaphragm component 16 is ventilated, a braking force is applied to the brake linings assigned to wheel 10. If, on the other hand, diaphragm component 16 is vented, the brake linings are released again—provided that the parking brake is not actuated. Diaphragm component 16 is connected for this purpose to further components of an electronic brake system via a compressed air line 20.

An electropneumatic parking brake modulator, which is assigned to the parking brake, has a control unit 22. An electronic brake system, which controls the service brake, has, for its part, a further electronic control unit 24. In an alternative embodiment, both control units are, however, merged to form a common unit. An electrical or electronic control device 26, which is illustrated in FIG. 1, includes the two control units 22, 24. Control device 26 can, however, be formed either in one housing or in a plurality of assemblies in different housings.

Compressed air line 18 and compressed air line 20 can be, respectively, ventilated and vented by means of one or more valve devices 28, 30. Valve device 28 is preferably arranged in an electropneumatic modulator of the parking brake. Valve device 30 is preferably arranged in an electropneumatic modulator of the electronic brake system. Of these valve devices, FIG. 1 schematically illustrates only a single valve for spring accumulator component 14 and for diaphragm component 16.

Control device 26 also has a timer 32, which is accommodated either within control unit 22 and/or control unit 24 or separately therefrom within control device 26.

Control device 26 is, in addition, provided with a monitoring sensor 34 by means of which it is possible to monitor whether or not a driver keeps his foot in contact with a pedal, for example the brake pedal, the clutch pedal and/or the accelerator pedal. Monitoring sensor 34 can be embodied, for example, as a sensor that is arranged on the pedal. Additionally or alternatively, monitoring sensor 34 can, however, also include a pressure sensor for measuring a pressure that can be generated by a brake pedal actuation process in a line of the service brake circuit. Additionally or alternatively, monitoring sensor 34 can, however, also be embodied as an electrical sensor that senses mechanical loading on the pedal. By means of monitoring sensor 34, it is therefore possible to detect whether or not the driver has his foot in contact with the pedal.

In addition to, or as an alternative to, monitoring of the pedal or pedals, it is also possible to monitor an actuation element that is to be actuated manually, for example a momentary contact switch.

In addition, control device 26 is connected to an actuation element 36 that is arranged in the driver's cab. By actuating actuation element 36, the driver can actuate rolling brake function of the brake device to prevent the vehicle from rolling away unintentionally when the vehicle is stationary. The vehicle is equipped for this purpose with a movement sensor 38. This may be a wheel speed sensor that measures the rotational speed of a wheel. The sensor is, for example, an inductive wheel sensor which scans a pole wheel with a plurality of teeth, for example 80 teeth, and, in this way, determines the rotational speed of the wheel and therefore the speed of the vehicle. However, at very low vehicle speeds, such sensors prove problematic, depending on their design, so that other sensor systems are used. In particular, sensors that do not output the measurement signal directly but rather condition it firstly are employed. For this purpose, the respective sensor is integrated with a measurement signal processing device for conditioning a measurement signal. For example, in the measurement signal conditioning system, a pulse-width-modulated signal is generated and then transmitted to control device 26. Such sensors are defined by their capability to sense very slow vehicle speeds, for example below 1 km/h.

In addition, a plurality of sensors, i.e., in particular both the above-mentioned wheel speed sensors with a pole wheel and the above-mentioned sensors with a measurement signal conditioning means, can, respectively, transmit signals to control device 26 to determine if the vehicle is moving, which signals are then logically combined with one another to check their plausibility and to obtain the most precise value for any vehicle movement that is occurring. In particular, even very slow movements of the vehicle can therefore be sensed by movement sensor or sensors 38, and consequently also speeds below 1 km/h.

In one particular embodiment, control device 26 is also connected to one or more detectors 40 for detecting system failures. Detector or detectors 40 can be used to determine whether there are one or more faults in the brake device and, possibly, its components. For example, one of the detectors 40 may be a pressure sensor that can sense any unintentional drop in pressure in, for example, a compressed air reservoir vessel. In addition, one of the detectors 40 can be a voltage detector that can detect a critical state of an electrical power source.

By means of detectors 40 for detecting the system failures, control device 26 can initiate the methods discussed in greater detail hereinafter for securing the anti-roll lock. The same applies to the signals that are output by the above-mentioned components, monitoring sensor 34 and movement sensor 38.

The control device is also connected to an acoustic signal device 42, for example a horn, or in a visual signal device 44, for example a flashing light.

Control device 26 can actuate signal devices 42, 44 so that, for example, the acoustic signal device outputs an acoustic signal tone, or the visual signal device outputs a visual signal.

FIG. 2 is a schematic flowchart representing a method according to an embodiment of the present invention. In a step S1, the rolling brake function is first actuated by actuating actuation element 36 during a stationary state of the vehicle (which can be detected by movement sensor 38). In a step S2, monitoring is carried out by means of monitoring sensor 34 to determine whether or not the driver is keeping his foot on the brake pedal. If the driver is not keeping his foot on the brake pedal, the method continues to a step S3 in which the parking brake is then applied directly in reaction to the foot no longer being located on the brake pedal.

However, if it is detected in step S2 that the driver continues to keep his foot on the brake pedal, renewed checking of the brake pedal according to step S2 is carried out by means of a branching process 46.

This method of control of the brake device allows a very high degree of protection of the rolling brake function to be achieved since, whenever the driver is no longer directing the necessary attention to possible rolling away of the vehicle, the parking brake is automatically engaged by control device 26.

FIG. 3 shows a further exemplary embodiment which corresponds partially to the exemplary embodiment shown in FIG. 2, in particular as far as steps S1, S2 and branching process 46 are concerned. However, in this exemplary embodiment, in step S2 it is detected that the driver is not keeping his foot on the brake pedal and a branching process to step S4 occurs. In step S4, timer 32 is triggered before then waiting for a first time period. As soon as timer 32 has expired, a warning signal sounds in a step S5. In a step S6, the service brake at a first group of wheels is then switched over to the parking brake. That is, diaphragm component 16 is also ventilated like spring accumulator component 14, as a result of which, on the one hand, the service brake at these wheels is released and, on the other hand, the storage spring becomes effective and the parking brake is engaged. The first group of wheels advantageously includes the wheels of the rear axle or axles which are provided with spring accumulator brake cylinders.

The process then moves to a step S7 in which timer 32 is then triggered again before waiting for a second time period. After this second time period has expired, a warning signal is output in a step S8 and the anti-roll lock is deactivated in a step S9 by releasing the service brake. This is done by ventilating diaphragm component 16.

If the vehicle can no longer be held, for example, on a large positive gradient, in this state as a result of the parking brake, which is still actuate, the driver can increase the braking force in the usual way by actuating the service brake.

Although the output of warning signals in steps S5 and S8 was mentioned above, in an alternative exemplary embodiment these steps are omitted and no corresponding warning signals are output.

FIG. 4 shows a further exemplary embodiment of a method according to the invention. As in the exemplary embodiments according to FIGS. 2 and 3, this corresponds to steps S1, S2 and branching process 46.

However, if it is detected in step S2 that the driver is no longer keeping his foot on the brake pedal, a branching process to step S10 occurs. In step S10, control device 26 ensures that such pressure is applied to compressed air line 20 that the maximum braking force which can be generated by spring accumulator component 14 is applied to the brake of wheel 10 by diaphragm component 16. Spring accumulator component 14 remains vented here, with the result that the parking brake is not applied.

As a result of this state, the driver can detect whether the vehicle can at all be secured by means of the parking brake. In fact, the braking force of the parking brake is possibly not sufficient, for example in the case of an excessively steep negative gradient. In this case, the driver can secure the vehicle again by actuating the service brake.

Monitoring of the brake pedal with respect to contact with the driver's foot has been described in step S2 in relation to the respective flowcharts for FIGS. 2 to 4 discussed above. Instead of the brake pedal, it is, however, also possible to use a different pedal, for example the accelerator pedal or the clutch pedal. In one alternative exemplary embodiment there is also the possibility of monitoring a further pedal that is provided specifically for this purpose. Finally, a combination of a plurality of pedals can also be monitored.

Moreover, an alternative exemplary embodiment provides for monitoring an actuation element that is to be actuated manually. For example, for this purpose, a momentary contact switch or a contact sensor is provided. In one particular exemplary embodiment, a combination of a plurality of actuation elements is monitored.

FIG. 5 shows a further exemplary embodiment. Step S1 corresponds again to step S1 discussed in the examples above, i.e., the anti-roll lock is actuated and the vehicle is stationary. In the following step S11, monitoring is carried out to determine whether the stopped vehicle is beginning to move again. If the vehicle does not move, a branching process 46 back to step S11 takes place. If, on the other hand, the vehicle moves, such a movement being detected by means of movement sensor or sensors 38, a branching process to step S12 occurs. In step S12, control device 26 then automatically brakes all the wheels of the vehicle by means of the service brake provided that the wheels are connected to the service brake.

In an optional step S13, a warning signal is then output.

FIG. 6 shows a further exemplary embodiment according to the present invention. Step S1 corresponds again to step S1 discussed above, i.e., the anti-roll lock is actuated and the vehicle is stationary.

In a following step S14, a check is performed to determine whether a failure is present in the electronic brake system or in one of its components. If this is not the case, the method is returned to step S14 via branching process 46. However, if a failure of the electronic brake system or of one of its components is detected by means of sensor or sensors 40, the parking brakes are engaged in a step S15.

In an alternative exemplary embodiment, system failure sensors 40 are not required. Instead, the parking brake is engaged automatically if specific electrical conditions, for example in the event of a failure of the electrical voltage supply, and/or specific pneumatic conditions, for example in the event of a failure of the pneumatic pressure supply, are met. Such automatic engagement of the parking brake is advantageously effected by means of solenoid valves of corresponding design.

In all the exemplary embodiments, a warning signal is advantageously output when there is a change of state of the service brake and/or of the parking brake which is initiated automatically, in particular by the control device, which warning signal can be output, for example, as an acoustic and/or visual warning signal by means of a horn and/or a flashing warning light.

All the features discussed in the above description and in the claims can be used according to the invention both individually and in any desired combination with one another. The invention is therefore not restricted to the described or claimed combinations of features. Instead, all combinations of individual features are considered as being disclosed.

### LIST OF REFERENCE NUMBERS

10 Wheels
12 Spring accumulator brake cylinder
14 Spring accumulator component
16 Diaphragm component
18 Compressed air line
20 Compressed air line
22 EPH control unit
24 EBS control unit
26 Control device
28 Valve device
30 Valve device
32 Timer
34 Monitoring sensor
36 Actuation element
38 Movement sensor
40 Detector for detecting system failures
42 Acoustic signal device
44 Visual signal device
46 Branching process
48 Branching process
50 Branching process

1. A method for operating a brake device of a motor vehicle having a service brake (16) and a parking brake (14), wherein, when a rolling brake function is actuated and a stationary state of said vehicle is brought about, monitoring (S2) of an actuation element is carried out to determine whether a driver maintains contact with the actuation element, wherein if the monitoring (S2) reveals that the driver does not have any contact with the actuation element, an electrical or electronic control device (26) for controlling the service brake (16) and the parking brake (14):
a) engages (S3) the parking brake (14) or
b) modulates (S10) by means of the service brake (16), a brake pressure which corresponds to the maximum brake pressure which can be generated by the parking brake (14).

2. The method as claimed in claim 1, wherein the parking brake (14) is engaged (S6) before the service brake is completely released (S9).

3. The method as claimed in claim 2, wherein, after a first time period (S4), the service brake is released (S6) only at a first group of wheels, in particular only at the wheels (10) at which spring accumulator brake cylinders (12) are provided, and at the same time the parking brake (14) is engaged at this group of wheels (10), and after a second time period (S7) the service brake (16) is also released at all the other wheels.

4. The method as claimed in claim 3, wherein, directly before the expiry of the first and/or second time period, a warning signal (S5, S8) is output.

5. A method for operating a brake device of a vehicle having a service brake (16) and a parking brake (14), wherein, when a rolling brake function (S1) is actuated and a stationary state of the vehicle is brought about, monitoring (S11) of the vehicle for any movement of the vehicle is carried out, and if the monitoring reveals that the vehicle has begun to move, an electrical or electronic control device (26) brakes (S12), by means of the service brake (16), all the wheels of the vehicle which are connected to the service brake (16).

6. The method as claimed in claim 5, wherein a warning signal (S13) is output if the monitoring (S11) reveals that the vehicle has begun to move.

7. The method as claimed in claim 5 or 6, defined by the features of a method as claimed in one of claims 1 to 4.

8. The method as claimed in claim 4, 6 or 7, wherein the warning signal (S5; S8; S13) is an acoustic signal, in particular a signal which is output by means of a horn of the vehicle, and/or a visual signal, in particular a light signal or flashing light signal which is output by means of the lights of the vehicle.

9. The method as claimed in one of the preceding claims, wherein monitoring (S14) of the brake device and, if appropriate, of its components is carried out, and the parking brake (14) is engaged if the monitoring (S14) reveals that there is a fault in the brake device and/or possibly in its components, in particular if there is a failure of a brake circuit and/or of an electrical power supply.

10. An apparatus for operating a brake device of a motor vehicle having a service brake (16) and a parking brake (14), an actuation element (36) for actuating a rolling brake function and monitoring means (34) for monitoring an actuation element to determine whether a driver maintains contact with the actuation element, defined by an electrical or electronic control device (26) for controlling the service brake (16) and the parking brake (14) which is configured such that if the monitoring reveals that the driver does not have any contact with the actuation element:
a) the parking brake (14) can be engaged, or
b) a brake pressure that corresponds to the maximum brake pressure that can be generated by the parking brake (14) can be modulated by means of the service brake (16).

11. The apparatus according to claim 10, wherein the control device is configured to carry out the method as claimed in one of claims 1 to 4 and 8 and 9.

12. The apparatus as claimed in claim 10 or 11, wherein the actuation element is a pedal that is arranged in the driver's cab, in particular a brake pedal, clutch pedal and/or accelerator pedal.

13. The apparatus as claimed in one of claims 10 to 12, wherein the actuation element is a manual actuation element, in particular a momentary contact switch, that is arranged in the driver's cab.

14. The apparatus as claimed in one of claims 10 to 13, wherein the monitoring means (34) have a sensor that is arranged on the actuation element.

15. The apparatus as claimed in one of claims 10 to 14, wherein the monitoring means (34) has a pressure sensor for measuring a pressure that can be generated by brake pedal actuation in a line of a service brake circuit.

16. The apparatus as claimed in one of claims 10 to 15, wherein the monitoring means (34) have an electrical sensor for measuring a force that can be applied to the brake pedal by the driver.

17. An apparatus for operating a brake device for a motor vehicle having a service brake (16) and a parking brake (14), an actuation element (36) for actuating a rolling brake function and monitoring means (38) for monitoring the vehicle for any movement of the vehicle, defined by an electrical or electronic control device (26) for controlling the service brake (16) and the parking brake (14), that is configured such that if the monitoring reveals that the vehicle is beginning to move, all the wheels of the vehicle that are connected to the service brake (16) can be braked by means of the service brake (16).

18. The apparatus as claimed in claim 17, wherein the control device is configured to carry out a method as claimed in one of claims 5 to 9.

19. The apparatus as claimed in claim 17 or 18, defined by a movement sensor (38) for sensing a movement of the vehicle.

20. The apparatus as claimed in claim 19, wherein the movement sensor (38) is a wheel speed sensor.

21. The apparatus as claimed in claim 19, wherein the movement sensor (38) is a sensor having a measurement signal processing device for conditioning a measured measurement signal.

22. The apparatus as claimed in one of claims 17 to 21, defined by the features of an apparatus as claimed in one of claims 10 to 16.
